(19) United States
(12) Patent Application Publication
(10) Pub. No.: US 2006/0226013 A1
(43) Pub. Date: Oct. 12, 2006

(54) Manipulation of objects with fluid droplets

(76) Inventors: Michel Marcel Jose Decre, Eindhoven (NL); Ronald Martin Wolf, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/539,968

(22) PCT Filed: Nov. 17, 2003
(86) PCT No.: PCT/IB03/05255

§ 371 Date: Jun. 19, 2005

(30) Foreign Application Priority Data
Dec. 18, 2002 (EP) 02080391.2

(51) Int. Cl. G01N 27/00

(52) U.S. Cl. 204/601

(57) ABSTRACT

A system for manipulation of a small object comprises a carrier to transport the small object to a substrate to receive the small object. A fluid droplet which couples the small object detachably to the carrier and/or to the substrate. The coupling of the small object to the fluid droplet relative to the coupling of the fluid droplet to the substrate is electrically controlled on the basis of the electrowetting effect.

Manipulation of small objects is in particular of relevance in the fabrication of semiconductor devices. Small electronic components need to be placed accurately on a substrate. Often a crystalline Si wafer is used as the substrate. It appears that the cost of semiconductor devices is strongly dependent on the size of the substrate, so that the more semiconductor devices made on the substrate, the lower the production cost per semiconductor device. The number of semiconductor devices accommodated on the substrate, given the size of the surface of the substrate, is increased as smaller sized components are employed. These components need to be manipulated, for example in that they need to be picked-up and placed accurately at predetermined positions on the substrate.

The invention pertains to a system for manipulation of a small object.

Such n system for manipulation is known from the U.S. Pat. No. 6,294,063.

The known system for manipulation concerns in particular manipulation of encapsulated packets. The known system comprises a reaction surface configured to provide an interaction site for the encapsulated packet. Further an inlet port is provided coupled to the reaction surface to introduce the encapsulated packet onto the reaction surface. A programmable manipulation force is generated to move the packet about the reaction surface by arbitrarily chosen paths. The manipulation force is generated by way of an electric field or by way of a light source. The manipulation force may include a dielectrophoretic force, an electrophoretic force, an optical force or a mechanical force.

A drawback of the known system is that the encapsulated packets can only be moved over the reaction surface so that the manipulation becomes more cumbersome as more encapsulated packets are placed on the reaction surface. Further, the size of the encapsulated packets is in the range from 100 nm to 1 cm.

An aim of the invention is to provide a system for manipulating a small object which is more flexible in particular in applications where a larger number of small objects are to be manipulated. Another aim of the invention is to provide a system for manipulating small objects that is able to manipulate small objects that are smaller than the known encapsulated packets.

These aims are achieved by a system for manipulation of small objects according to the invention comprising a carrier to transport the small object

a substrate to receive the small object and

a fluid droplet which couples the small object detachably to the carrier and/or to the substrate.

The system according to the invention for manipulation of small objects operates on the basis of the physical phenomenon of surface wetting. In particular, electrically controlled surface wetting, electrowetting, can advantageously be employed.

The system for manipulation of a small object of the invention makes use of a fluid droplet for detachably coupling the small object to a carrier on which the small object is despatched to the substrate. Such a droplet may also or alternatively be used to couple the small object to the substrate upon arrival. In one example, the small object is weakly bonded, e.g. by Van der Waals forces, to the carrier and transported to the substrate. Then the small object is brought into contact with the fluid droplet on the substrate. The bonding of the small object to the fluid droplet is stronger than the bonding to the carrier and when the carrier moves away the small object remains behind coupled to the substrate by the fluid droplet. Finally the fluid droplet is removed, e.g. by evaporation. In another version the fluid droplet couples the small object to the carrier during transportation. Upon arrival the small object is coupled to the substrate more strongly than to the fluid droplet. When the carrier is moved away, the coupling between the fluid droplet and the small object breaks and the small object is left behind on the substrate.

The system for manipulation of small objects of the invention is in particular used to manipulate small objects having a carrying side with a moderate wettability for the carrying fluid at issue. When in operation, the carrying fluid droplet is employed to pick-up the small object at a carrying side of the small object. When the carrying fluid droplet is moved close to the small object, the adhesion between the small object's carrying side and the fluid of the carrying fluid droplet couple the small object to the carrying fluid droplet. Then the carrying fluid droplet loaded with the small object is transported to the small object's destination on the substrate. Further, the adhesion of the small object with the carrying fluid droplet is so low that the adhesion between the small object's side facing the destination area and the destination area is higher than the moderate adhesion between the carrying fluid droplet and the small object's carrying side. The moderate wettability and the accordingly moderate adhesion between the small object's carrying side and the carrying fluid droplet should be high enough to enable sufficient bonding of the small object to the fluid carrying fluid droplet and on the other hand the moderate adhesion should be low enough so that there is a higher wettability and accordingly higher adhesion between the small object and the substrate onto which the small object is to be deposited. Notably, the accordingly higher adhesion should at least relate to the side of the small object that faces the substrate when deposited and the surface of the destination area of the fluid droplet on the substrate where the small object is deposited.

There are various ways to dispose the small object from the target fluid droplet on the substrate. Notably, the small object may be glued to the substrate at the destination area after the small object has been transported to the destination area on the target fluid droplet; also other ways of bonding are feasible such as using wax which is cooled when the small object has arrived at its destination or the small object is bonded to the substrate at its destination by way of soldering.

The present system for manipulation of a small object is particularly suitable to manipulate very small objects, which are markedly smaller than the small objects that are manipulated by the known system for manipulation of a small object. The system for manipulation of a small object of the invention can manipulate small objects having dimension in the range of 20 μm to 500 μm. The system for manipulation of a small object of the invention is further suitable to manipulate in parallel a plurality of small objects.

Various liquids are suitable to form the fluid droplet and even a vapour bubble may be used. The carrying fluid droplet should have adhesion and consequently surface tension which allows the fluid droplet to carry the small object in a stable way. The target fluid droplet should have a higher adhesion with the small object than the carrying fluid with the small object, or the elctrowetting effect should allow the adhesion of the target droplet with the small object to be increased above the adhesion of the small object with the carrying droplet.

These and other aspects of the invention will be further elaborated with reference to the embodiments defined in the dependent Claims.

Preferably, the system for manipulation of a small object is provided also with a target fluid droplet on the substrate and the small object has a target side with a high wettability. That is, the carrying side has a moderate adhesion for the carrying fluid, while the target side has a higher adhesion for the target fluid. In many applications the same fluid can be used for both the carrying fluid droplet and for the target fluid droplet. For example when the fluid is water or an aqueous solution, the carrying side is moderately hydrophilic to a low degree while the target side is more strongly hydrophilic.

When in operation, the carrier picks up the small object to be manipulated with the carrying fluid droplet directed to the small object's carrying side. Then the small object is weakly linked to the carrier by way of the carrying fluid droplet. For example the small object rests on the carrying fluid droplet or when a somewhat hydrophilic carrying side is employed the small object can be suspended from the carrier. The carrier with the small object linked to the carrying fluid droplet, i.e. the carrying fluid droplet being loaded with the small object, is then moved to the substrate such that the small object with its target side makes contact to the target fluid droplet. As the target side is more strongly hydrophilic, the small object is more strongly linked to the target fluid droplet than to the carrying fluid droplet. By moving the carrier away from the substrate, the link of the carrying fluid droplet with the small object breaks first and the small object remains linked to the target fluid droplet on the substrate. Thus the small object is placed on the substrate. Usually, the target fluid droplet is then removed, for example by evaporation of the fluid of the target fluid.

Preferably, the substrate is prepared in advance in that the target fluid droplets are placed at predetermined positions or in a predetermined spatial pattern. Consequently, the small object or small objects are automatically positioned at these predetermined positions or according to the predetermined pattern. Hence, there is no need for a cumbersome search for a suitable path over the substrate surface for the small object to reach its destination on the substrate.

Particularly good results for picking-up the small object and placing it at an appropriate position are obtained when the carrying and target fluid droplets are relatively small in relation to the small object such that the ratio of the size of the fluid droplet, especially ratio of the thickness of the fluid droplet when it rests on the carrier or the substrate, to the size of the small object, especially the dimension of the small object in the direction transverse to the fluid droplet at issue is in the range 1/10 to 1/3. Most advantageously, this ratio is about 1/5. In this range of 1/10 to 1/3 for the ratio of transverse size of the small object and thickness of the fluid droplets stable equilibrium is achieved of the small object carried by or suspended from the fluid droplet at issue. Notably, inadvertent breaking-up of the carrying fluid droplet or of the target fluid droplet hardly ever occurs when the ratio of the size of the small object and the fluid droplet is in the preferred range. Further, the thickness of the fluid droplet at issue should be well below ½, i.e. less than ⅓ of the transverse size (width) of the small object so that the small object rests in a stable way on top of the fluid droplet. On the other hand the fluid droplet should not be too thin relative to the width of the small object so that fluid droplet can effectively separate the small object from a surface on which the fluid droplet is disposed. In particular the fluid droplet should preferably not be thinner than 1/10 of the width of the small object. Thus, the movement of the fluid droplet loaded with the small object is not hampered by irregularities of the surface over which the loaded fluid droplet is moved.

Preferably, the substrate is provided with one or several electrodes. These electrodes can be provided on or under the surface of the substrate. These electrodes can be activated by applying an electrical voltage. This electrical voltage influences the interaction between the carrying fluid droplet and the surface of the substrate. Notably, the contact angle of the carrying fluid droplet and the surface of the substrate increases with the modulus of the electrical potential of the substrate relative to the fluid. That is, the substrate is made more hydrophilic in the region of the electrodes when an electrical voltage is applied. This phenomenon is often termed ‘electrowetting’ and is discussed in more detail in the paper ‘Reversible electrowetting and trapping of charge: Model and Experiments’, by H. J. J. Verheijen and M. W. J. Prins in Langmuir 19(1999)6616-6620. In operation, the electrode is activated when the small object to be manipulated is brought into contact with the target fluid droplet. Then the electrowetting effect causes the surface of the substrate to be more hydrophilic, so that the target fluid droplet concentrates near the region of the electrode. Further, when the electrode is activated the small object is more strongly bound to the target fluid droplet than to the carrying fluid droplet, it is easier to break the link between small object and the carrying fluid droplet when the carrying fluid droplet moves away.

More preferably, the electrode is spatially shaped so that it corresponds with the shape of the small object to be manipulated. When the small object is placed on the target fluid droplet, the electric field of the electrode causes the small object on the target fluid droplet to be orientated automatically along the shape of the electrode. As the target fluid evaporates, the small object lands on top of the electrode. Accordingly, the small objects to be manipulated so as to be rotated or flipped over and can be available in random orientations and no special steps are needed to place the small objects in their correct orientations on the substrate.

A very practical embodiment of a system for manipulation of small objects in which the invention is employed is defined in Claim 8. Pick-up carrying fluid droplets are disposed from a reservoir on the pick-up plate. In general a large number of pick-up carrying fluid droplets are disposed on the pick-up plate. Preferably, the pick-up plate is provided with a plurality of electrodes in a predetermined spatial pattern. Upon activation of these electrodes, the pick-up carrying fluid droplets are disposed automatically according the pattern of these electrodes. In particular a micro-fluidic array is practical for the deposition of many pick-up carrying fluid droplets on the pick-up plate. Notably, the micro-fluidic array allows parallel handling of a large number of pick-up carrying fluid droplets. Subsequently, the pick-up carrying fluid droplets on the pick-up plate are loaded with the small objects, for example by lifting them from a storage plate. The small objects to be manipulated are then despatched to the feeding plate on which the feeder target fluid droplets are disposed. The pick-up plate loaded with the small objects and the feeding plate carrying the feeder target fluid droplets are moved close to one another so that the small objects are brought into contact with their high wettability sides with the feeder target fluid droplets provided on the feeding plate. The pick-up plate and the feeding plate are then moved away from one another so that the small objects are lifted off or picked-up from the feeding plate. The target fluid droplets loaded with the small objects are then shipped to the placing plate via a joint which links the feeder plate with the placing plate. The joint may be a flexible joint, so that the pick-up plate and the placing plate can be moved relative to one another while they remain linked by the flexible joint. The feeder plate has several electrodes which upon activation render the region around the activated electrodes more hydrophilic. Adjoining electrodes are successively activated so that the target fluid droplet is moved e.g. step by step over the electrodes toward the flexible joint. The loaded target fluid droplets may be transported over the flexible joint to the placing plate. That is, the loaded target fluid droplets are allowed to roll down the flexible joint onto the placing plate. To this end, the flexible joint is provided with its adjoining electrodes. Then the loaded feeder target fluid droplets are transported over the flexible joint by successive activation of the electrodes of the flexible joint. In this way the feeder target droplets also function to carry the small objects from the feeder plate via the joint to the placing plate.

Suitable designs for the adjoining electrodes and the control of the successive activation of these electrodes to control the transportation of the fluid droplets are disclosed per se in the paper ‘Electrowetting-based actuation of liquid droplets for microfluidic applications’ by M. G. Pollack et al. in Appl. Phys. Lett. 77(2000)1725-6.

The placing plate is provided with a pattern of placing electrodes. When the placing electrodes on the placing plate are activated the feeder target fluid droplets loaded with the small objects are easily displaced over the placing plate and/or orientated on the placing plate on the basis of the electrowetting effect that is caused when the placing electrodes of the placing plate are activated by applying a voltage to them. Preferably the system for manipulation of small objects of the invention is provided with a detection system which distinguishes loaded carrying fluid droplets from empty carrying fluid droplets. Integrated optical detectors are quite suitable to detect the presence or absence of small objects on the carrying fluid droplets. Empty feeder target fluid droplets are removed from the pick-up plate. This is achieved by deactivating electrodes on which an empty fluid droplet is detected so that the empty fluid droplet is no longer held in place. This deactivation of electrodes on the pick-up plate is controlled on the basis of an output signal of the detection system. Electrodes are deactivated when the output signal corresponds to an empty carrying fluid droplet. A drain line having electrode segments may be provided to evacuate the empty droplets.

Finally the small objects on the feeder target droplets are carried over to the device substrate. On the device substrate there are provided substrate electrodes which upon activation hold substrate fluid droplets in place. The placing plate and the device substrate are moved to one another so that the small objects on the placing plate make contact with the substrate fluid droplets. Under control of the voltages applied to the substrate electrodes on the device substrate and to the placing electrodes on the placing plate, the adhesion of the substrate fluid droplets with the small objects is made higher than the adhesion of the feeder target droplets on the placing plate with the small object. Then the device substrate and the placing plate are moved away from each other and the small objects remain on the device substrate. The substrate fluid droplets are then removed, e.g. simply be evaporation. Preferably, the substrate electrodes are shaped to as to orientate the small objects upon activation of the substrate electrodes. The substrate electrodes are further disposed according to a pre-determined pattern that corresponds to a circuit lay out of an electronic circuit to be formed on the device substrate. Thus, the small objects are placed according to a pattern and orientation of the pre-determined pattern of the substrate electrodes. Hence, when the substrate fluid droplets have been removed, on the device substrate there is formed an electronic circuit having very small components that are constituted by the very small objects. The substrate electrodes may then function as electrical connections in the electronic circuit.

These and other aspects of the invention will be elucidated with reference to the embodiments described hereinafter and with reference to the accompanying drawing wherein

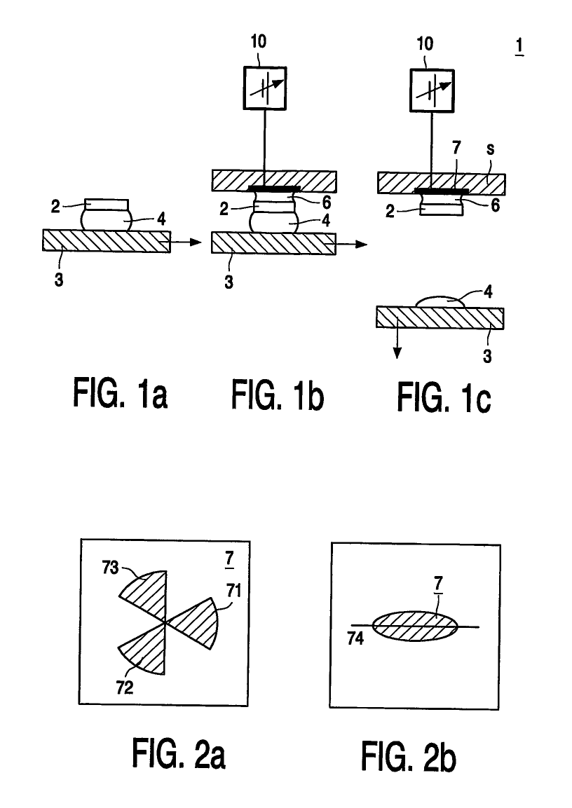

FIG. 1 shows a schematic representation of the system of the invention

FIG. 2 shows two a schematic examples of electrodes employed in the substrate of the system of the invention

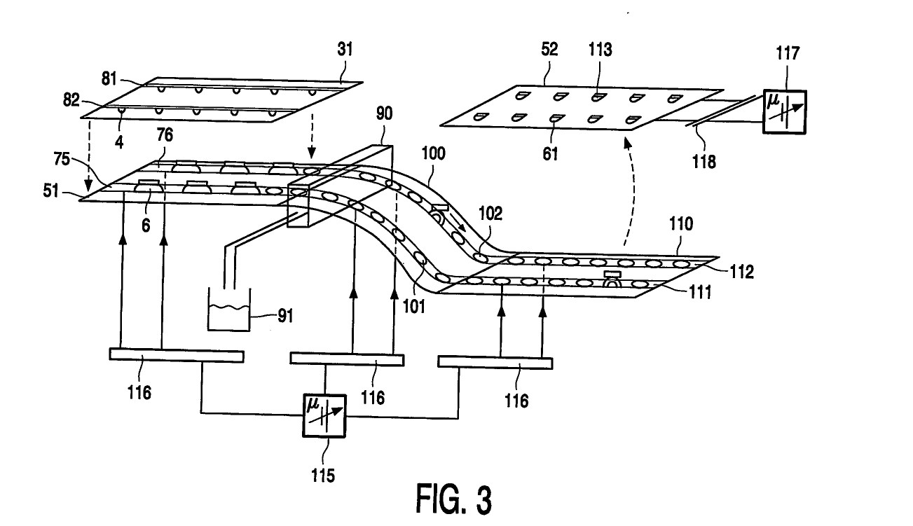

FIG. 3 shows a practical embodiment of a system for manipulation of a small object in which the invention is employed.

FIG. 1 shows a schematic representation of the system 1 of the invention. The small object 2 is initially (a) placed on the carrying fluid droplet 4 on the carrier 3. The carrier 3 then moves towards a substrate 5 on which the small object is to be placed. The carrier 3 moves (b) the small object near the target fluid droplet 6 that is disposed on the substrate 5 so that the small object makes contact with the target fluid droplet. The side of the small object 2 which is brought into contact with the target fluid droplet 6 is the small object's high wettability side so that the small object becomes more strongly bonded to the target fluid droplet 6 than to the carrying fluid droplet 4. In the next phase (c) of operation of the system for manipulation of a small object the carrier and the substrate are moved away from each other, usually by moving the carrier 3 away from the substrate 5. Then the link between the small object 2 and the carrying fluid droplet breaks first and the small object 2 remains linked to the target fluid droplet 6 and is the small object 2 suspended from the substrate 5. The substrate 5 is provided with an electrode 7 that is coupled to a voltage source 10. The voltage source 10 applies an electric voltage to the electrode and as a consequence, by way of the electrowetting effect, the adhesion of the target fluid droplet and the small object, notably the high wettability side of the small object, is substantially enhanced. The voltage applied by the voltage source 10 to the electrode is adjustable, so as to control the adhesion of the target fluid droplet with the small object.

FIG. 2 shows two a schematic example of electrodes employed in the substrate of the system of the invention. In particular, FIGS. 2a and 2b show top views of two examples of electrodes 7 which are shaped according to the small objects involved. FIG. 2a shows the electrode 7 having three sectors 71, 72, 73. This electrode is particularly suitable to orientate the small object according to the orientation of the sectors 71, 72, 73. Namely, when the voltage is applied to the electrode 7, the electrowetting effect is stronger near the sectors 71,72, 73 than in the areas between the sectors. Hence, it is energetically favourable for the small object to align according the sectors 71,72,73. Similarly, FIG. 2b shows the electrode 7 having an elongate shape, in particular an ellipse which is quite suitable to orientate the small object along the long axis 74 of the electrode 7.

FIG. 3 shows a practical embodiment of a system for manipulation of a small object in which the invention is employed. In the embodiment of FIG. 3, as the carrier 3 the pick-up plate 31 is used on which several electrodes 81, 82 are provided. A large number of pick-up carrying fluid droplets 4 are placed on the pick-up plate according to pattern by which the electrodes are activates. Subsequently, the pick-up carrying fluid droplets 4 are loaded with the small objects. In the embodiment of FIG. 3 the small objects are suspended from the pick-up plate. Similarly as shown in the simple example in FIG. 2, the pick-up plate 31 is moved towards the feeding plate 51 that is employed as the substrate on which the small objects are placed. The feeding plate 51 is provided with several electrodes 75, 76. On the feeding plate 51, there are placed several feeder target fluid droplets 6. The location of the feeder target fluid droplets is controlled on the basis of the electrowetting effect by the voltages that are applied to the electrodes 75,76 and the shape of the electrodes 75,76 on the feeding plate 51. The pick-up plate 31 is moved towards the feeding plate 51 so as to bring the small objects 4 on the pick-up plate into contact with the feeder target fluid droplets. In the next phase the pick-up plate 31 is moved away from the feeding plate leaving the small objects on the feeding plate. The system for manipulation of a small object is shown in this phase of operation in FIG. 3, where the pick-up plate 31 has just delivered the small objects 4 to the feeding plate 51. As shown in FIG. 3, some of the target fluid droplets are not loaded with a small object. The electrodes 75,76 on the feeding plate 51 are segmented and adjacent electrode segments are individually addressable with the voltages. By successively activating adjacent electrode segments, the target fluid droplets are moved over the feeding plate 51. The target fluid droplets from the feeding plate 51 are applied to the detection system 90 where unloaded target fluid droplets are identified and removed to a reservoir 91. The loaded target fluid droplets are subsequently moved over the flexible joint 100 the placing plate 110. Both the flexible joint 100 and the placing plate 110 are provided with segmented electrodes 101, 102 and 111,112. The loaded target fluid droplets are moved over the flexible joint under control of voltages applied successively to the adjacent segments of the electrodes 101, 102 of the flexible joint 100. Finally, the loaded target fluid droplets are parked at their intended positions on the placing electrodes 111, 112 on the placing plate 110. The loaded target fluid droplets are parked on the placing plate under control of the voltages applied to the segments of the electrodes 111,112 on the placing plate.

To apply the voltages to the segments of the electrodes 75,76 on the feeding plate 51, to the segments of the electrodes 101, 102 on the flexible joint 100 and to segments of the placing electrodes 111, 112 on the placing plate 110, the system for manipulation of a small object is provided with the adjustable voltage source 115 which is also provided with a micro-processor (μ). The voltage source 115 is coupled to the segments of the several electrodes by way of an electronic voltage distribution system 116. The micro-processor (μ) is programmed to control the successive appliance of voltages to the adjacent segments of the electrodes of the feeding plate, the flexible joint and the placing plate. Finally, the placing plate with the small objects being loaded on the feeder target droplets now held in place on the placing electrodes that are activated is moved to the device substrate 52. On the device substrate there are provided substrate target droplets 61. The placing plate and the device substrate are moved so close to each other that the small objects on the target feeder droplets 6 on the placing plate 110 make contact with the substrate target droplets 61. On the substrate substrate electrodes 113 are provided that can be activated by way of a voltage source 117 with a microprocessor and an electronic voltage distribution system 118. When the substrate electrodes 113 on the device substrate are activated and the placing electrodes 111,112 on the placing plate are deactivated, the small objects are linked to the substrate target droplets 61 and detached from the feeder target droplets 6 on the placing plate 110. Once the loaded target fluid droplets with their small objects are disposed at their proper positions on the device substrate, the substrate target fluid droplets removed e.g. by evaporation so that the small objects are then disposed on the placing plate. For example, when the small objects are tiny integrated circuits, they form a larger electronic circuit formed on the device substrate.

1. A system for manipulation of a small object comprising
a carrier to transport the small object
a substrate to receive the small object and
a fluid droplet which couples the small object detachably to the carrier and/or to the substrate.

2. A system for manipulation of a small object as claimed in claim 1 wherein
a carrying fluid droplet is disposed on the carrier.

3. A system for manipulation of a small object as claimed in claim 1, wherein
a target fluid droplet is disposed in the substrate.

4. A system for manipulation of a small object as claimed in claim 1, wherein the target fluid droplet is placed on the substrate in predetermined positions or in a predetermined pattern.

5. A system for manipulation of a small object as claimed in claim 1, wherein the ratio of size of the fluid droplets to the size of the objects is in the range 1/10 to 1/3.

6. A system for manipulation of a small object as claimed in claim 1, wherein the substrate is provided with one or several electrodes.

7. A system for manipulation of small objects as claimed in claim 4 wherein the electrodes have a shape which corresponds to a shape of the small objects.

8. A system for manipulation of a small object, comprising
a pick-up plate on which pick-up carrying droplets are disposed
a feeding plate on which feeder target droplets are disposed
a placing plate on which several placing electrodes are disposed
the feeding plate and the placing plate being coupled by a joint, in particular by a flexible joint and
a device substrate on which substrate target droplets are disposed.

9. A system for manipulation of a small object as claimed in claim 6 being provided with
a detection system responsive to the carrying fluid droplets on the pick-up plate to distinguish carrying fluid droplets carrying the small objects from empty fluid droplets and
a droplet discard system responsive to the detection system to remove the empty fluid droplets from the pick-up plate.

10. A method of manipulation of a small object having a carrying side with high wettability and a target side with low wettability
placing said small object with its low wettability side on a carrying fluid droplet on a carrier
bringing said carrier with the small object with its high wettability side into contact on deposition area on a substrate
moving the carrier away from the substrate.

11. A method as claimed in claim 10, wherein with a target fluid droplet is placed at the deposition area.
